(19) United States
(12) Patent Application Publication
(10) Pub. No.: US 2024/0384738 A1
(43) Pub. Date: Nov. 21, 2024

(54) ADAPTER/EXTENDER FOR A SHOWER/TUB HANDLE TO VALVE CONNECTION

(71) Applicant: LORDAHL MANUFACTURING CO., Waukegan, IL (US)

(72) Inventor: Var E. Lordahl, Waukegan, IL (US)

(21) Appl. No.: 18/198,276

(22) Filed: May 16, 2023

(51) Int. Cl. F16B 7/00

(52) U.S. Cl. CPC F16B 7/00; F16K 31/60

(57) ABSTRACT

The present invention is directed to an adapter or extender that can be used in plumbing applications in which the adapter or extender, either singly or coupled together in a series of at least two or more of the same, can cooperatively engage with other plumbing devices (e.g., a stop tube) to complete a shower or tub handle to valve connection. The adapter or extender can be made (e.g., by injection molding) from any suitable hard material (e.g., a material comprising an elastomer or thermoplastic rubber (TPR)), or a dynamically vulcanized polymer alloy of cured EPDM (ethylene propylene diene monomer) rubber in a polypropylene (PP) matrix), which can optionally be further blended with additional polymer such as polypropylene to control hardness to a desired level). The material may be formulated and manufactured such that it can be easily cut or shortened (e.g., with a utility knife) to any desired size.

### FIELD OF THE INVENTION

The present invention relates generally to an adapter or extender that may be used in plumbing applications, and, more particularly, to an adapter or extender that may be used singly, or in a series of two or more of the same coupled together when longer lengths are required, as part of an assembly that is used to connect a shower or tub handle to a valve that may be positioned at various distances from the handle depending on site construction.

### BACKGROUND OF THE INVENTION

Referring to FIG. 1 (prior art) showing a typical shower or tub handle to valve installation 100, a shower or tub handle 110 (e.g., a knob handle) for controlling the flow of water by rotation thereof is typically positioned adjacent to, or substantially flush with, a wall's interior face (not shown), usually with an escutcheon (not shown) placed therebetween. The shower or tub handle 110, or in some instances the escutcheon, may have one or more holes 111 for fastener(s), such as screw(s) 114 and washer(s) 112, which can be used to attach (either directly or indirectly) the shower or tub handle 110 to the valve 140 (e.g., valve stem 144) located at some distance behind the wall. The hole(s) 111, when present in the shower or tub handle 110, may be covered with a shower or tub handle cover 116. The handle 110 may be provided with a handle bushing 118, which may cooperate with a stop tube (center tube) 120 (usually made of a metallic material such as chrome or stainless steel), into which is inserted an adapter 130 into the other open end of the stop tube 120. That end of the stop tube 120 is then slipped over the valve 140's body.

Buildings with showers and/or tubs are constructed in certain sequences, which usually include, for example:
a. performing rough carpentry;
b. performing rough plumbing and work involving electricals (mechanicals) attached to the rough carpentry;
c. installing insulation and putting up walls (e.g., drywalls);
d. finishing plumbing and electricals; and
e. finishing carpentry.

Rough plumbing includes installing the pipes and valve bodies only onto the rough carpentry. By the time the walls and tiling are completed, distances typically vary from where the rough valve body was attached to the rough carpentry and to where the wall finally projects out. Tub or shower faucet manufacturers must accommodate for these variances-most commonly, by using a center tube (stop tube) that mounts on the faucet body and protrudes out to the escutcheon and seals off so as to accommodate distance variances created by the rough and finished crews.

Years later, if remodeling takes place, the work often involves replacing the existing walls with new walls or thicker tiles. Indeed, many property owners, especially owners or operators of apartment building/complexes or other multi-dwelling units, may elect only to renovate the walls surrounding the shower or tub rather than undertake a full shower or tub remodeling or upgrade with new plumbing because valves tend to last a very long time. This is especially common where quick, easy, and low-cost fixes are the norm. In such instances, the wall renovation may alter the distance between the shower or tub handle 110 and the valve 140 to be off by a significant amount (e.g., about an inch or so), depending on the thickness of the selected wall material (e.g., ceramic tiles). Consequently, the original stop tube (center tube) may be too short to reach out to where the new wall or tiles projects out. In such instances, either the valve must be moved at great expense, or an extension kit must be used to reconnect the escutcheon and the handle.

Specifically, once the adapters, original escutcheon, and tube are installed, the handle must be mounted onto the factory-provided stem which is recessed deep into the center tube. Depending on how far the positioning of the center tube was changed after the remodeling project, the handle might not reach the recessed stem to allow it to be attached to the cartridge. Heretofore, manufacturers such as Moen, provided brass extension adapters to connect the handle to the recessed stem or an extension kit including a longer stop tube to accommodate some deviation in distances. This prior solution, however, may require cutting of the metallic stop tube, which may not only be difficult to do but can also result in deformation and razor sharp edges that may potentially injure an installer.

Accordingly, there still remains a need in the art to provide an effective solution to offset the typical distance deviations that can often occur in the connection of shower or tub handles to valves while allowing the original handle components to be kept.

### SUMMARY OF THE INVENTION

The present invention, described below, provides an effective solution for overcoming one or more of the deficiencies of the known prior art described above.

The present invention provides a different approach in that it works from behind the wall rather than from front of the valve, as will be described herein, and thus does not require a long stop tube that must be cut. Specifically, the present invention, in some embodiments, can provide a series of short, stackable adapters with a trimmable handle screw to connect the cartridge to the handle. Since the adapters according to the present invention can be stackable, they “telescope” together to cover various lengths as may be needed.

The present invention is directed to an adapter or extender that can be used in plumbing applications in which the adapter or extender, either singly or coupled together in a series of at least two or more of the same, can cooperatively engage with other plumbing devices (e.g., a stop tube) to complete a shower or tub handle to valve connection. The adapter or extender can be made (e.g., by injection molding) from any suitable hard material (e.g., a material comprising an elastomer or a thermoplastic rubber (TPR) such as SANTOPRENE® (a dynamically vulcanized polymer alloy of cured EPDM (ethylene propylene diene monomer) rubber in a polypropylene (PP) matrix), which can optionally be further blended with additional polymer such as polypropylene to control hardness to a desired level). The material may be formulated and manufactured such that it can be easily cut or shortened (e.g., with a utility knife) to any desired size to allow customization of the length required to complete the handle to valve connection for any given installation, thus eliminating the need to cut the metallic stop tube, which can be more difficult and comes with a risk of damaging the original stop tube in a way that renders it unusable and/or dangerous to the installer due to the sharp edges of the cut. The adapter or extender may have a generally tubular shape with at least two contiguous, generally tubular portions that may each be configured to have a cross-sectional shape that can allow the adapter or extender to couple with another plumbing element (e.g., a stop tube), or to another adapter or extender of identical configuration and size.

When two or more adapters or extenders of the same configuration and size are coupled together, one of the generally tubular portions (i.e., a first generally tubular portion with a relatively smaller overall cross-section) would be the male part, while the other generally tubular portion (i.e., a second generally tubular portion with a relatively larger overall cross-section) would be the female part, where the male part on one adapter or extender can mate with a female part on another adapter or extender (i.e., the male part is inserted into the female part in an axial direction) in a close or tight-fitting, rotatably (radially) locked relationship. Rotational locking may be provided by the mating insertion of a raised locking feature such as a raised notch or ridge having a suitable height and width as well as flat sides along a length of an exterior surface of the first generally tubular portion on one adapter or extender into a corresponding recessed opening of conforming shape and size in a second generally tubular portion in another adapter or extender. The coupling or mating of the adapter or extender with another plumbing device such as a stop tube can be implemented in a similar manner. For example, the first generally tubular portion of the adapter or extender with the raised feature (e.g., a raised notch or ridge) can be configured to be axially insertable into the stop tube's recessed opening, which has a cross-sectional shape that will conform to the outer cross-sectional shape of the first generally tubular portion, such that mating can occur in a close or tight-fitting, rotatably locked manner.

In general, the raised feature of the adapter or extender according to the present invention, as well as cross-sectional shape and size thereof, may be configured to be compatible with any recessed openings prevalent in all existing or prior center tubes or stop tubes. e.g., but not limited to, all MOEN® current and prior product lines including MOEN® Posi-Temp as well as other manufacturers' products).

In one aspect of the invention, an adapter or extender comprises:
(a) a first generally tubular portion having a first uniform cross-section defining a first opening and a first outer surface; and
(b) a second generally tubular portion having a second uniform cross-section defining a second opening and a second outer surface, the second generally tubular portion being contiguous with the first generally tubular portion and the second opening and the second outer surface being larger than the first opening and the first outer surface, respectively;
wherein the first and second uniform cross-sectional shapes of the first and second tubular portions, respectively, are configured to allow: (i) coupling of another device with the first generally tubular portion in a rotatably locked configuration; and (ii) coupling of the first generally tubular portion with a second opening in a second generally tubular portion of another identical adapter or extender in a rotatably locked configuration.

In another aspect of the invention, the another device is a stop tube for connecting a shower or tub handle to a valve.

In another aspect of the invention, the coupling with the stop tube is provided by a first generally tubular portion having a first uniform cross-section configured to allow the first generally tubular portion to be at least partially insertable into a corresponding opening in the stop tube in a mating and rotatably locked configuration.

In another aspect of the invention, the coupling of the adapter or extender to the stop tube is by sliding one end of the stop tube over the first generally tubular portion in a rotatably locked configuration.

In another aspect of the invention, the rotatably locked coupling of the adapter or extender to the stop tube is provided by a raised notch or ridge, positioned along a lengthwise portion of the first outer surface of the first generally tubular portion, that is engageable with a recess, corresponding to the shape of the raised notch or ridge on the first generally tubular portion, provided on an inner surface of the stop tube.

In another aspect of the invention, coupling with another identical adapter or extender is provided by a first generally tubular portion having a first uniform cross-section with a first outer surface configured to allow the first generally tubular portion to be at least partially insertable into a corresponding second opening of an identical adapter or extender in a mating and rotatably locked configuration.

In another aspect, the mating and rotatably (radially) locking function between two or more identical adapters or extenders is provided by a raised notch or ridge, positioned along a lengthwise portion of a first outer surface of a first generally tubular portion on one adapter or extender, that is engageable with a corresponding lengthwise recess in a second opening of a second generally tubular portion in another adapter or extender.

In another aspect, raised notches or ridges are provided on each exterior surface of the first and second generally tubular portions, wherein the raised notches or ridges have flat sides that protrude radially from the first and second generally tubular portions.

In another aspect of the invention, two or more adapters or extenders may be coupled together to form a desired length.

In another aspect of the invention, the adapter or extender is made of a rubber or thermoplastic rubber (TPR) material and optionally additional polypropylene.

In another aspect of the invention, the adapter or extender is injection molded from rubber or thermoplastic rubber (TPR) material and optionally additional polypropylene.

In another aspect of the invention, the rubber or thermoplastic rubber comprises recycled or virgin SANTOPRENE® (a dynamically vulcanized polymer alloy of cured EPDM (ethylene propylene diene monomer) rubber in a polypropylene (PP) matrix).

In another aspect of the invention, the rubber or thermoplastic rubber material and optionally additional polypropylene has a sufficient hardness for use as part of a connection between a shower or tub handle and a water supply valve.

In another aspect of the invention, the rubber or thermoplastic rubber is cuttable (e.g., with a utility knife) without significant deformation or damage.

In another aspect of the invention, a device comprises an adapter or extender according to the present invention coupled with a stop tube.

In another aspect of the invention, a device comprises two or more identical adapters or extenders according to the present invention coupled together.

In another aspect of the invention, a device comprises two or more adapters according to the present invention and a stop tube, all coupled together.

### BRIEF DESCRIPTION OF THE DRAWINGS

The preferred embodiments of the invention will hereinafter be described in conjunction with the appended drawings provided to illustrate but not limit the invention, where like designations denote like elements, and in which:

FIG. 1 (prior art) presents an exploded view of a typical shower or tub to water supply valve connection;

FIG. 2 presents a perspective view of an adapter or extender in accordance with one embodiment of the present invention;

FIG. 3 presents a top view of the adapter or extender shown in FIG. 2;

FIG. 4 presents a bottom view of the adapter or extender shown in FIGS. 2 and 3;

FIG. 5 presents a view facing the first generally tubular portion of the adapter or extender shown in FIGS. 2-4;

FIG. 6 presents a view facing the second generally tubular portion of the adapter or extender shown in FIGS. 2-5;

FIG. 7 presents a side view of the adapter or extender shown in FIGS. 2-6 coupled to a stop tube that is engaged in a rotatably locked fashion over the first generally tubular portion (hidden) of the adapter or extender;

FIG. 8 presents a side view of two identical adapters or extenders that are coupled to each other, where one of the two adapters or extenders is also coupled to a stop tube to provide a longer overall length than that of the combination shown in FIG. 7;

FIG. 9 presents a side view of three identical adapters or extenders that are coupled together in series, where one of the three adapters or extenders is also coupled to a stop tube to provide a longer overall length than those of the combinations shown in FIGS. 7 and 8; and

FIG. 10 shows the combination shown in FIG. 9 in separated form.

Like reference numerals refer to like parts throughout the several views of the drawings.

### DETAILED DESCRIPTION OF THE PREFERRED EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Some features may be described using relative terms, such as “upper,” “lower,” “left,” “rear,” “right,” “front,” “vertical,” or “horizontal.” Such positional relative terms are only for reference with respect to the appended Figures and are not meant to limit the disclosed embodiments.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting but merely exemplary, unless the claims expressly state otherwise.

Furthermore, a person skilled in the art would understand from reading this disclosure that “a” and “an” each generally denotes “at least one,” but does not exclude a plurality unless the contextual use dictates otherwise. Also, the term “or” in a list of enumerated items denotes “at least one of the items” and, therefore, does not exclude a plurality of items of the list.

Shown throughout the figures, the present invention is directed toward an adapter or extender 230 that may be used for plumbing applications, e.g., as part of an assembly that may be used for connecting a shower or tub handle 110 to a water supply valve 140.

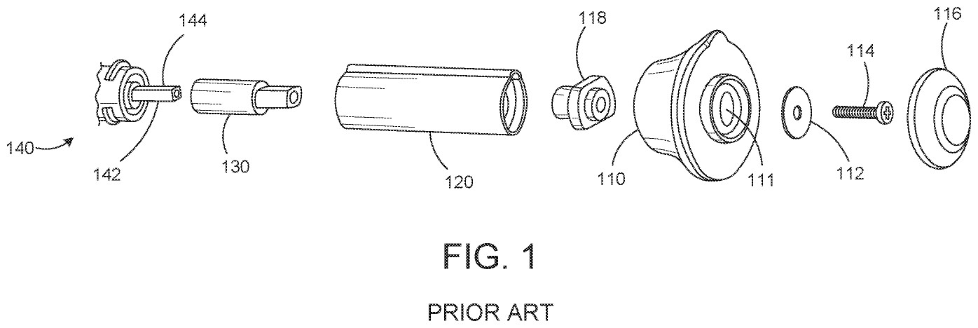

FIG. 1 (prior art) shows a typical shower or tub handle 110 connection to a water supply valve 140, via a conventional adapter 130, as described above.

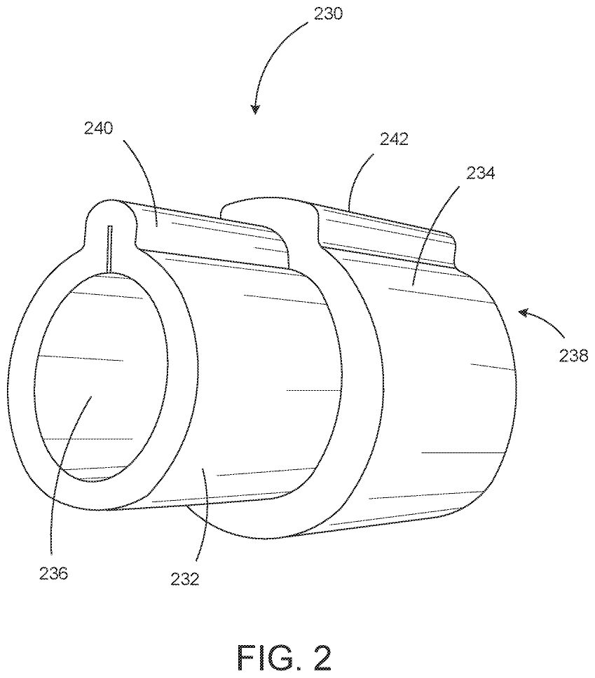

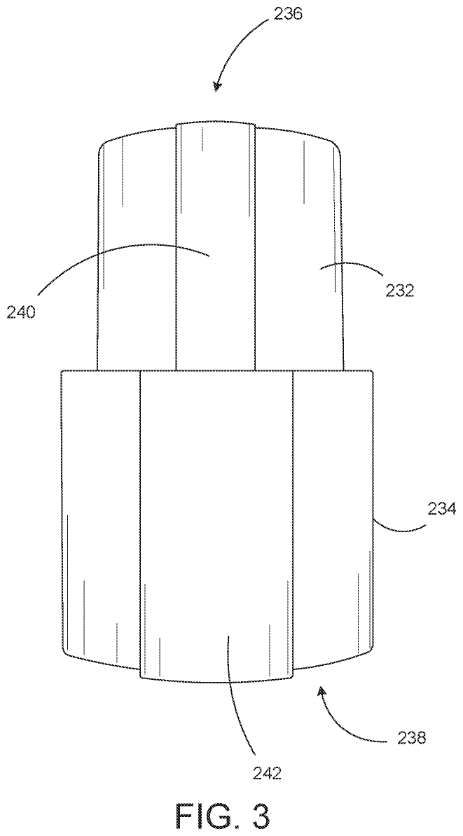

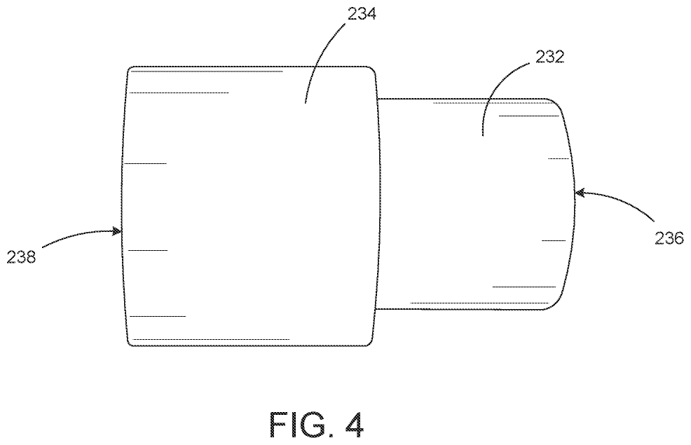

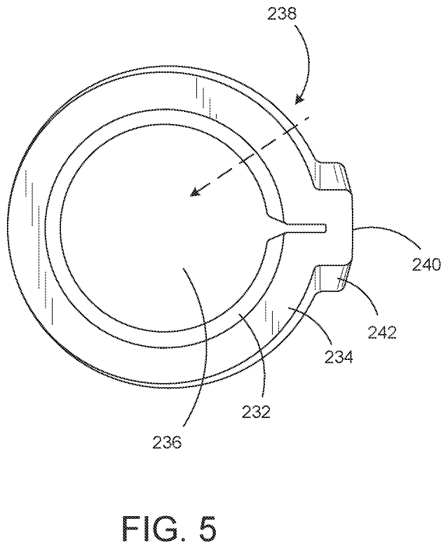

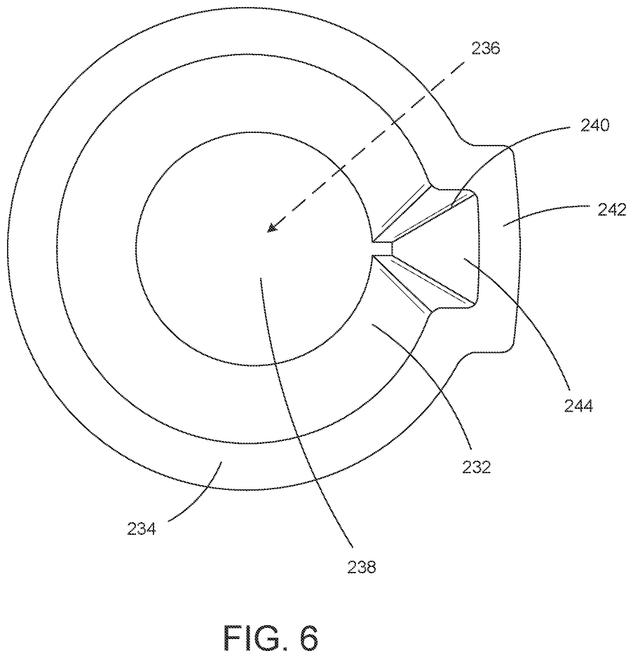

FIGS. 2-6 show an adapter or extender 230 according to an embodiment of the present invention. As may be seen in FIG. 2, the adapter or extender 230 is exemplified as comprising a first generally tubular portion 232 having a first opening 236 (see also FIG. 5) and a relatively larger second generally tubular portion 234 having a second opening 238 (not shown in FIG. 2; see FIG. 6). The first generally tubular portion 232 and the second generally tubular portion 234 are contiguous, as may be seen in FIGS. 2-4.

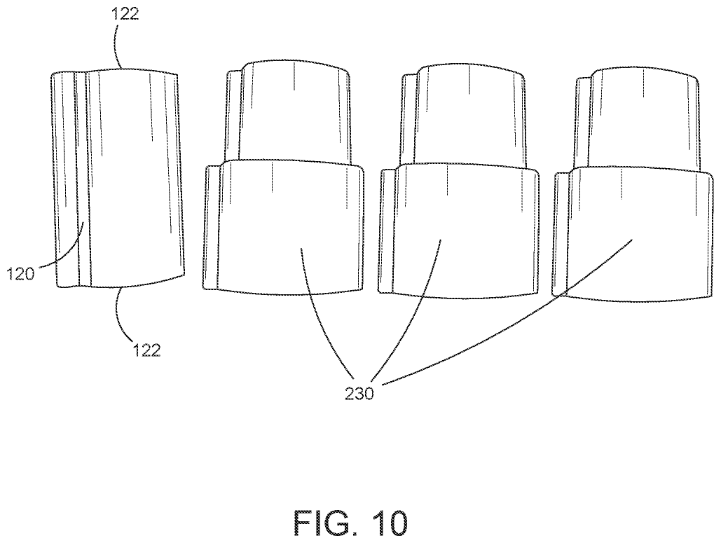

As best seen in FIGS. 2, 3, and 5, the top of the first generally tubular portion 232 may be provided with a raised feature (e.g., a notch or ridge) 240 that will engage, in a close or tight-fitting, rotatably locked configuration, with a corresponding recess in an opening of another device (e.g., opening 122 of a stop tube 120 as shown in FIG. 10), or a second opening 238 of a second generally tubular portion 234 of another identical adapter or extender 230. The second generally tubular portion 234 also has a protruding raised feature 242 to accommodate a recess 244 (FIG. 6) for receiving raised feature 240 on a first generally tubular portion 232 of another identical adapter or extender 230.

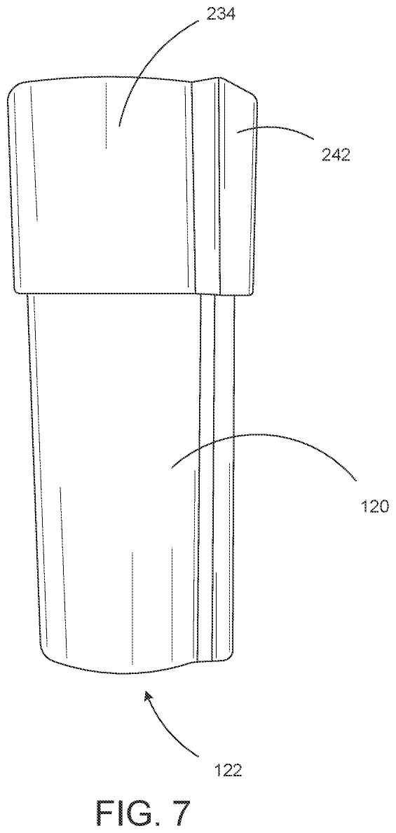

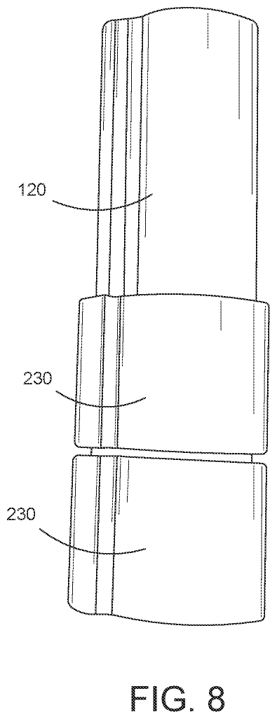

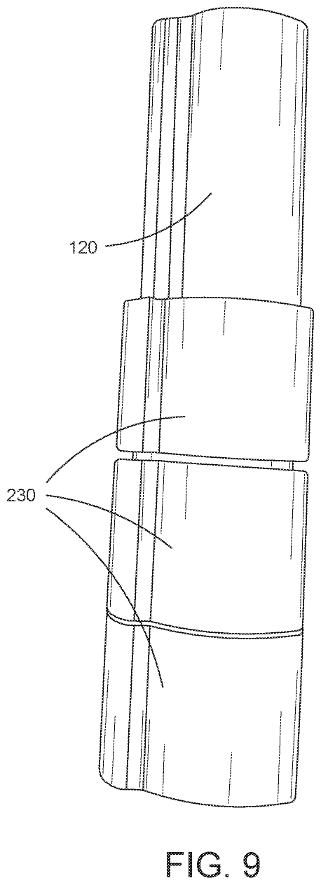

Thus, as will be understood from FIGS. 8-10, the outer contours of the cross-section of the first generally tubular portion 232 will conform (in a close or tight-fitting, rotatably locked relationship) to the second opening 238 of the second generally tubular portion 234 of another identical adapter or extender 240. Similarly, as may be seen in FIGS. 7-10, the outer contours of the cross-section of the first generally tubular portion 232 will conform (in a close or tight-fitting, rotatably locked relationship) to an opening 122 in stop tube 120. As stated previously, the raised feature of the adapter or extender according to the present invention, as well as cross-sectional shape and size thereof, may be configured to be compatible with any recessed openings prevalent in all existing or prior center tubes or stop tubes (e.g., but not limited to, all MOEN® current and prior product lines including MOEN® Posi-Temp as well as other manufacturers' products). However, other configurations are possible.

It is also within the scope of the present invention, unless otherwise recited in the appended claims, that it is possible to modify the configuration of the adapter or extender 230 in such a way that the stop tube can be inserted into one of the generally tubular portions of the adapter or extender 230, provided that other configuration adjustments are made.

It should also be understood that it may be possible to provide multiple handle bushings 118 that can couple with each other to further extend the distance required to connect the handle 110 to the valve 140.

Since many modifications, variations, and changes in detail can be made to the described embodiments and aspects of the invention, it is intended that all matters in the foregoing description and shown in the accompanying drawings be interpreted as illustrative and not in a limiting sense. Thus, the scope of coverage of the invention should be determined by the appended claims and their legal equivalents.

What is claimed is:

1. An adapter or extender comprising:
(a) a first generally tubular portion having a first uniform cross-section defining a first opening and a first outer surface; and
(b) a second generally tubular portion having a second uniform cross-section defining a second opening and a second outer surface, the second generally tubular portion being contiguous with the first generally tubular portion and the second opening and the second outer surface being larger than the first opening and the first outer surface, respectively;
wherein the first and second uniform cross-sectional shapes of the first and second tubular portions, respectively, are configured to allow: (i) coupling of another device with the first generally tubular portion in a rotatably locked configuration; and (ii) coupling of the first generally tubular portion with a second opening in a second generally tubular portion of another identical adapter or extender in a rotatably locked configuration.

2. An adapter or extender according to claim 1, wherein the coupling (i) and (ii) forms a close or tight-fitting relationship.

3. An adapter or extender according to claim 1, wherein the another device is a stop tube for connecting a shower or tub handle to a water supply valve.

4. An adapter or extender according to claim 3, wherein the coupling with the stop tube is provided by a first generally tubular portion having a first uniform cross-section configured to allow the first generally tubular portion to be at least partially insertable into a corresponding opening in the stop tube in a mating and rotatably locked configuration.

5. An adapter or extender according to claim 3, wherein the coupling of the adapter or extender to the stop tube is by sliding one end of the stop tube over the first generally tubular portion in a rotatably locked configuration.

6. An adapter or extender according to claim 5, wherein the rotatably locked coupling of the adapter or extender to the stop tube is provided by a raised notch or ridge, positioned along a lengthwise portion of the first outer surface of the first generally tubular portion, that is engageable with a recess, corresponding to the shape of the raised notch or ridge on the first generally tubular portion, provided on an inner surface of the stop tube.

7. An adapter or extender according to claim 1, wherein coupling with another identical adapter or extender is provided by a first generally tubular portion having a first uniform cross-section with a first outer surface configured to allow the first generally tubular portion to be at least partially insertable into a corresponding second opening of an identical adapter or extender in a mating and rotatably locked configuration.

8. An adapter or extender according to claim 7, wherein the mating and rotatably (radially) locking function between two or more identical adapters or extenders is provided by a raised notch or ridge, positioned along a lengthwise portion of a first outer surface of a first generally tubular portion on one adapter or extender, that is engageable with a corresponding lengthwise recess in a second opening of a second generally tubular portion in another adapter or extender.

9. An adapter or extender according to claim 7, wherein raised notches or ridges are provided on each exterior surface of the first and second generally tubular portions, wherein the raised notches or ridges have flat sides that protrude radially from the first and second generally tubular portions.

10. A device comprising an adapter or extender according to claim 1 coupled to another identical adapter or extender.

11. A device comprising an adapter or extender according to claim 1 coupled to a stop tube.

12. A device according to claim 10, further comprising a coupled stop tube.

13. An adapter or extender according to claim 1 made of a rubber or thermoplastic rubber (TPR) material and optionally additional polypropylene.

14. An adapter or extender according to claim 12 formed by injection molding.

15. An adapter or extender according to claim 12, wherein the TPR material is a dynamically vulcanized polymer alloy of cured EPDM (ethylene propylene diene monomer) rubber in a polypropylene (PP) matrix.

16. An adapter or extender according to claim 14, wherein additional polypropylene is present to control hardness.
